(19) United States
(12) Patent Application Publication
(10) Pub. No.: US 2026/0301002 A1
(43) Pub. Date: Oct. 1, 2026

(54) GENERATING DESTINATION-SPECIFIC IDENTIFIERS UTILIZING A ZERO-DAY MODEL

(71) Applicant: Chime Financial, Inc., San Francisco, CA (US)

(72) Inventors: Yufan Qiu, Berkeley, CA (US); Wei Xu, Los Altos, CA (US); Zheng Sun, San Mateo, CA (US); Stephen Yan, Saratoga, CA (US); Jingwei Yang, San Francisco, CA (US); Lei Pei, Sunnyvale, CA (US); Andrew Ratcliffe, San Francisco, CA (US); Luyen Le, San Francisco, CA (US)

(21) Appl. No.: 19/096,078

(22) Filed: Mar. 31, 2025

(51) Int. Cl. G06Q 30/0201; G06F 11/30

(52) U.S. Cl. CPC G06Q 30/0201; G06F 11/302

(57) ABSTRACT

The present disclosure relates to methods, systems, and non-transitory computer-readable media for determining a value-based threshold for generating digital content to surface to user accounts. In particular, the disclosed systems utilize a zero-day model to extract zero-day features from a plurality of data sources associated with a user account within an inter-network facilitation system. From the zero-day features, the disclosed systems may determine or derive destination-specific identifiers specific to one or more matching systems. The disclosed systems can also generate a zero-day score by utilizing the zero-day model to process the destination-specific identifiers. In some embodiments, the zero-day score indicates a likelihood of the user account establishing a direct-asset-transfer account within the inter-network facilitation system. Based on the zero-day score, the disclosed systems may determine a value-based asset threshold for generating digital content to surface to one or more user accounts (e.g., at the one or more matching systems).

### BRIEF DESCRIPTION OF THE DRAWINGS

The detailed description provides one or more embodiments with additional specificity and detail through the use of the accompanying drawings, as briefly described below.

FIG. 1 illustrates an overview of determining a value-based asset threshold for generating digital content to surface to user accounts in accordance with one or more embodiments.

FIG. 2 illustrates an example diagram of determining destination-specific identifiers from zero-day features in accordance with one or more embodiments.

FIG. 3 illustrates an example diagram of generating a zero-day data package for direct-asset-transfer accounts in accordance with one or more embodiments.

FIG. 4 illustrates an example diagram of causing a first matching system to generate digital content to surface to a first set of matching user accounts and a second matching system to generate digital content to surface to a second set of matching user accounts in accordance with one or more embodiments.

FIG. 5 illustrates an example diagram of monitoring a zero-day model to detect a data drift and modifying the zero-day model to account for the data draft in accordance with one or more embodiments.

FIG. 6 illustrates a diagram of an environment in which a zero-day determination system can operate in accordance with one or more embodiments.

FIG. 7 illustrates an example flowchart of a series of acts for determining a value-based asset threshold in accordance with one or more embodiments.

FIG. 8 illustrates a block diagram of an exemplary computing device in accordance with one or more embodiments.

FIG. 9 illustrates an example environment for an inter-network facilitation system in accordance with one or more embodiments.

### DETAILED DESCRIPTION

This disclosure describes one or more embodiments of a zero-day determination system that uses a zero-day model that (extracts and) processes destination-specific identifiers to determine a value-based threshold for generating digital content to surface (or provide) to user accounts. In particular, the zero-day determination system utilizes a zero-day model of an inter-network facilitation system to extract zero-day features from a plurality of data sources associated with a user account within the inter-network facilitation system. From the zero-day features, the zero-day determination system may determine or derive destination-specific identifiers. These destination-specific identifiers can include features (or identifiers) specific to one or more matching systems, including zero-day features determined to satisfy a threshold impact on a zero-day score and/or including derived destination-specific identifiers. The zero-day determination system can also generate a zero-day score by utilizing the zero-day model to process the destination-specific identifiers. In some embodiments, the zero-day score indicates a likelihood of the user account (e.g., the user account corresponding to the zero-day features and/or the destination-specific identifiers) establishing a direct-asset-transfer account within the inter-network facilitation system. Based on the zero-day score, the zero-day determination system may determine a value-based asset threshold for generating digital content to surface to one or more user accounts (e.g., at the one or more matching systems).

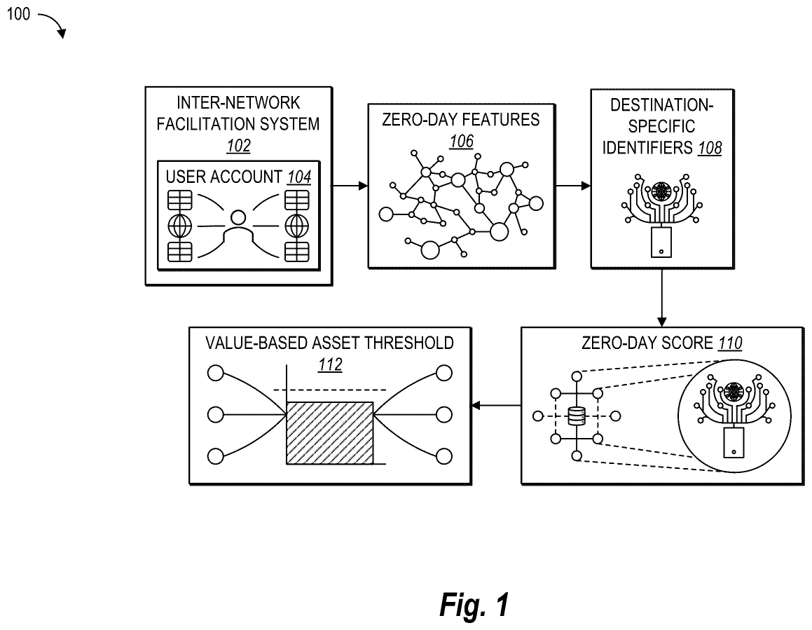

Additional detail regarding the zero-day determination system will now be provided with reference to the figures. For example, FIG. 1 illustrates an overview of determining a value-based asset threshold for generating digital content to surface to user accounts in accordance with one or more embodiments. Additional detail regarding the various acts and processes introduced in relation to FIG. 1 is provided thereafter with reference to subsequent figures.

As illustrated in FIG. 1, the zero-day determination system 100 detects a user account 104 within an inter-network facilitation system 102. To elaborate, the inter-network facilitation system 102 can host or store data for many user accounts of varying types to facilitate access to, transfer of, and other interactions with digital assets among interconnected systems. For example, the inter-network facilitation system 102 can host direct-asset-transfer accounts that perform direct-asset-transfer actions within the inter-network facilitation system 102. For such direct-asset-transfer accounts, the inter-network facilitation system 102 establishes secure connections that facilitate asset transfer from external systems (e.g., hosted at servers separate from those of the inter-network facilitation system 102) to the direct-asset-transfer accounts within the inter-network facilitation system 102. In some cases, the user account 104 is a direct-asset-transfer account while in other cases it is not.

As also illustrated in FIG. 1, the zero-day determination system 100 extracts zero-day features 106 from a plurality of data sources associated with the user account 104. In particular, the zero-day determination system 100 may utilize a zero-day model (e.g., a neural network or a set of neural networks working together) to extract the zero-day features 106 from the plurality of data sources. For example, the zero-day determination system 100 utilizes the zero-day model to extract the zero-day features 106 within a zero-day period (e.g., a period that is shorter than a threshold duration), as opposed to features extracted or derived over longer time periods. In some embodiments, the zero-day determination system 100 extracts the zero-day features 106 within the zero-day period upon receiving the indication of the initiation of the user account 104 within the inter-network facilitation system 102.

As additionally illustrated in FIG. 1, the zero-day determination system 100 determines destination-specific identifiers 108. Specifically, the zero-day determination system 100 can determine destination-specific identifiers 108 that include features specific to one or more matching systems at servers external to the inter-network facilitation system 102. In one or more embodiments, the zero-day determination system 100 determines the destination-specific identifiers 108 from the zero-day features 106. For example, the zero-day determination system 100 determines (e.g., utilizing the zero-day model) the destination-specific identifiers 108 from identifiers and/or features (e.g., from the zero-day features 106) that satisfy a threshold impact on a zero-day score 110 for the one or more matching systems. In one or more embodiments, the zero-day determination system 100 can derive (or predict) one or more of the destination-specific identifiers 108.

As further shown in FIG. 1, the zero-day determination system 100 generates the zero-day score 110. To generate the zero-day score, the zero-day determination system 100 can utilize the zero-day model to process the destination-specific identifiers 108 for the user account 104. In at least one embodiment, the zero-day score 110 can indicate a likelihood of the user account 104 establishing a direct-asset-transfer account within the inter-network facilitation system 102 as derived from zero-day features and/or destination-specific identifiers. In one or more embodiments, the zero-day score also indicates one or more additional or alternative considerations, such as future lifetime value. In some cases, the zero-day model thus includes multiple phases or stages (e.g., each executed by respective neural networks, heuristic functions, or specialized algorithms): one to extract zero-day features, another to determine or derive destination-specific identifiers from the zero-day features, and yet another to generate a zero-day score from the destination-specific identifiers.

As shown in FIG. 1, the zero-day determination system 100 determines a value-based asset threshold 112 for generating digital content to provide or surface to one or more user accounts. Specifically, the zero-day determination system 100 can determine the value-based asset threshold 112 based on the zero-day score 110. In at least one embodiment, the zero-day determination system 100 determines the value-based asset threshold 112 for generating digital content to surface to one or more user accounts at the one or more matching systems and/or at the inter-network facilitation system 102.

In one or more embodiments, the zero-day determination system 100 provides a zero-day data package to the one or more (third-party) matching systems. In particular, the zero-day determination system 100 generates the zero-day data package by collecting (or grouping or combining or associating) the destination-specific identifiers 108, the zero-day score 110, and/or the value-based asset threshold 112. Specifically, the zero-day determination system 100 generates the zero-day data package to include (a subset of the) data identifiers 108 that result in at least a threshold zero-day score 110 (excluding or omitting other data identifiers). Upon generating the zero-day data package, the zero-day determination system 100 can provide the zero-day data package to the one or more matching systems. In some embodiments, based on providing the zero-day data package, the zero-day determination system 100 requests or causes a matching system to determine matching user accounts (e.g., within the environment, system, or database of the matching system, different from the server environment of the zero-day determination system 100) that match or align with the destination-specific identifiers 108 and/or that match or align with (or are within a threshold probability of matching or aligning with) the zero-day score 110.

Based on providing such destination-specific identifiers 108 and the zero-day score 110 as part of the zero-day data package, the zero-day determination system 100 thus causes the matching system to generate digital content to surface to the matching user accounts. In some cases, the zero-day determination system 100 additionally analyzes (or causes a matching system to analyze) user accounts of the inter-network facilitation 102 (e.g., within the same server environment as the zero-day determination system 100) to identify matching accounts for surfacing digital content (e.g., as generated by the matching system).

By providing a zero-day data package to a particular matching system, the zero-day determination system 100 leverages the matching capabilities of the matching system to detect or identify other user accounts (e.g., within the environment of the matching system) that have features similar to those of the user account 104 corresponding to the zero-day score (and the destination-specific identifiers). Provided that the user account 104 is a direct-asset-transfer account, the zero-day determination system 100 thus uses the matching system as a proxy engine to identify (and surface digital content to) additional user accounts with at least a threshold likelihood of becoming direct-asset-transfer accounts, as indicated by the destination-specific identifiers 108 and the zero-day score 110.

Compared to the zero-day determination system 100 introduced above, prior systems often exhibit a number of shortcomings or disadvantages regarding the time periods for feature extraction, the accuracy or reliability of their features when extracted over shorter time periods, the speed of identifying matching user accounts, and/or the adaptability of models in such systems to changing circumstances that result in data drift.

As just suggested, existing account ingestion systems sometimes compare user accounts to identify matching user accounts, either in attempts to increase their numbers of user accounts (of a particular type) or for some other purpose. Often, these existing systems identify matching user accounts by extracting user account features over long data collection periods (e.g., multiple days). Indeed, existing systems are often reliant on features, such as user account behavior patterns, that mature over long time periods (e.g., multiple days, weeks, or longer). Consequently, existing systems are often too slow for the evolving standards of matching systems that perform matching or identification of similar user accounts, which standards sometimes require features extracted over time periods of less than a single day. Because many existing systems rely on processes that require accumulating data over extended time periods before they can process and provide an accurate and reliable data package, these systems identify fewer (or entirely miss) similar user accounts.

Some existing systems attempt to reduce their losses by providing extracted features at premature stages. Indeed, rather than adapt their features and the feature extraction process, many existing systems provide whatever underdeveloped features they can, which features are often inaccurate and unreliable. As a result, such systems determine poor user account matches and waste computational resources generating and distributing digital content to the substandard matches.

In addition, many existing systems are also rigid and fixed. For instance, although some existing systems incorporate mechanisms to update models periodically based on new data, such approaches are often constrained by static update cycles. Further, many existing systems require manual monitoring, interventions, and/or a full retraining to address data drifts in inputs and outputs or evolving trends. As a result, such existing systems frequently operate on outdated assumptions and parameters, leading to degraded performance and decreased responsiveness when underlying data patterns (e.g., extracted features) shift unexpectedly and/or when there are rapid or unpredictable changes, such as sudden real-world disruptions (like policy changes or global events) or shifts in user behavior, regional market trends, or external economic conditions.

In one or more embodiments, the zero-day determination system 100 can provide several improvements or advantages relative to existing systems. For instance, the zero-day determination system 100 can improve data reliability and speed relative to existing systems. In particular, in contrast with many existing systems that often require ascertaining which accounts are similar with at least a threshold confidence over long data collection periods (e.g., multiple days), the zero-day determination system 100 can determine matching or similar user accounts over a shortened time period (e.g., less than a day). For example, the zero-day determination system 100 can utilize a zero-day model to extract zero-day features from a plurality of data sources associated with the user account within a zero-day period. In some embodiments, the zero-day period can be within the same day and/or within hours (e.g., six hours or two hours) of receiving the indication of the initiation of the user account. In the same or other embodiments, the zero-day determination system 100 may additionally or alternatively, within the zero-day period, determine destination-specific identifiers from the zero-day features, generate a zero-day score, determine a value-based threshold, and/or provide one or more of the forgoing in a zero-day data package to one or more matching systems, all while maintaining accuracy and reliability of the zero-day data package.

Moreover, the zero-day determination system 100 can also improve functionality. For example, in contrast with many existing systems that provide whatever underdeveloped (and consequently inaccurate and unreliable) features they can at premature stages, the zero-day determination system 100 can provide accurate and reliable destination-specific identifiers in a zero-day period. To elaborate, during a zero-day period, the zero-day determination system 100 may determine a first subset of destination-specific identifiers that includes zero-day features which satisfy a threshold impact on a zero-day score. Yet, because the zero-day period may occur at an earlier stage in a feature-extraction process, the zero-day determination system 100 may not extract all features that are capable of satisfying the threshold impact. To compensate, the zero-day determination system 100 can derive (or predict) a second subset of destination-specific identifiers to account for any non-extracted zero-day features that may have otherwise satisfied the threshold impact if they had been extracted. For example, the zero-day determination system 100 utilizes the extracted zero-day features and an identifier derivation engine to derive (or predict) the second subset of destination-specific identifiers. Accordingly, the zero-day determination system 100 may provide an accurate and reliable zero-day data package to one or more matching systems within a shortened timeframe. Indeed, experimenters have demonstrated that, in some embodiments, the zero-day determination system 100 has a receiver operating characteristic (ROC) curve of at least 0.82, indicating that the zero-day determination system 100 has a high user account discrimination ability due at least in part to providing accurate and reliable zero-day data packages.

In addition to improving speed and functionality, the zero-day determination system 100 can also improve adaptability. For instance, contrary to existing systems that are often constrained by static update cycles and/or that require manual monitoring, interventions, and/or a full retraining to address data drifts or evolving trends, the zero-day determination system 100 can robustly monitor a zero-day model to detect a data drift and modify the zero-day model to account for the data draft. Indeed, the zero-day determination system 100 can monitor inputs and/or outputs of zero-day models to detect data drift. For example, the zero-day determination system 100 can monitor a zero-day model to detect a deviation in input data relative to an expected baseline and/or to detect a deviation in an output feature relative to an expected baseline. In some embodiments, the zero-day determination system 100 can modify, with and/or without user input/interaction, the one or more zero-day models to account for the one or more data drifts by, for example, modifying or removing a variable from the input data processed by the one or more zero-day models and/or adjusting parameters of the one or more zero-day models. Consequently, by monitoring for data drift and modifying zero-day models based on the data drift, the zero-day determination system 100 can adapt to unexpected shifts in data patterns and/or to rapid or unpredictable changes, such as sudden real-world disruptions (like policy changes or global events) or shifts in user behavior, regional market trends, and/or external economic conditions.

As illustrated by the foregoing discussion, the present disclosure utilizes a variety of terms to describe features and advantages of the zero-day determination system 100. Additional detail is now provided regarding the meaning of such terms. As used herein, the term “zero-day model” refers to a model trained, tuned, and/or designed to perform or execute (or to contribute to performing or executing) functions associated with one or more zero-day features. In particular, the zero-day model can extract zero-day features, derive destination-specific identifiers from zero-day features, and/or generate zero-day scores from zero-day features and/or destination-specific identifiers. In some embodiments, the zero-day model performs or executes (and/or contributes to performing or executing) one or more additional or alternative functions, such as determining value-based thresholds and/or generating zero-day data packages. In at least one embodiment, the zero-day model can be trained, tuned, and/or designed to perform or execute one or more functions in a zero-day period. Further, the zero-day model can be a machine learning model, such as a supervised learning model, a neural network (e.g., a deep neural network), or a regression model (e.g., to, for example, account for a data drift).

As also used herein, the term “zero-day period” refers to a period of time, less than or equal to a single day, wherein the zero-day determination system 100 may perform or execute one or more functions. In particular, the zero-day period can refer to a twenty-four-hour period (e.g., within the same day) and/or a less-than-twenty-four-hour period (e.g., six hours or two hours) after a user account registers (or registers as a direct-asset-transfer account) within a server environment, such as an inter-network facilitation system. Within a zero-day period, the zero-day determination system 100 may perform or execute one or more functions associated with zero-day features. For instance, the zero-day determination system 100 may perform or execute one or more functions in the zero-day period, such as: extracting zero-day features, determining destination-specific identifiers, generating zero-day scores, determining value-based thresholds, generating zero-day data packages, and/or providing the zero-day data packages to one or more matching systems. In at least one embodiment, the zero-day determination system 100 may perform or execute the one or more functions in the zero-day period upon receiving an indication of the initiation of a user account within an inter-network facilitation system.

As additionally used herein the term “zero-day features” refers to data attributes, characteristics, and/or parameters associated with a user account within an inter-network facilitation system as extracted over a zero-day period. In particular, zero-day features can include data points from a plurality of data sources that may describe the user account's interactions, preferences, activities, and/or account-related metadata within (or associated with) the inter-network facilitation system. For example, zero-day features can include client device ID, client device type (or version), operation system type (and/or version), user account type(s), an indication of whether the user account is using an application and/or web browser, engagement with digital content (including click locations), transaction history, frequency (or number) of logins, saved preferences, browsing activity, geolocation data, device type, demographic information, and/or one or more responses to questions.

Relatedly, as used herein, the term “destination-specific identifiers” refers to features, identifiers, or data elements that are determined and/or derived from zero-day features and that are specific to a particular matching system. Specifically, the zero-day determination system 100 may determine or derive the destination-specific identifiers from zero-day features based on relevance to, or use within, respective matching systems operating on servers external to an inter-network facilitation system (e.g., based on satisfying a threshold impact on a zero-day score). In some embodiments, the zero-day determination system 100 may determine the destination-specific identifiers by determining and/or deriving subsets of destination-specific identifiers and combining the subsets together.

As further used herein, the term “zero-day score” refers to a numerical or categorical value that represents a probability, confidence level, and/or ranking associated with a particular outcome related to a user account as derived from zero-day features and/or destination-specific identifiers. In particular, the zero-day score can indicate a likelihood of the user account establishing a direct-asset-transfer account within an inter-network facilitation system. In some instances, the zero-day determination system 100 may generate the zero-day score utilizing a zero-day model to process destination-specific identifiers for the user account.

Additionally, as used herein, the term “value-based asset threshold” refers to a dynamically generated allocation threshold for generating digital content for distribution to one or more user accounts, as driven by a zero-day score and/or destination-specific identifiers. Specifically, the value-based asset threshold can be an asset value that can be provided to (e.g., in a zero-day data package), and used by, one or more matching systems for generating digital content to surface to the one or more user accounts. For example, the value-based asset threshold can be provided to one or more user accounts at the one or more matching systems and/or to one or more user accounts within an inter-network facilitation system. In at least one embodiment, the zero-day determination system 100 generates the value-based asset threshold based on at least one zero-day score.

Along these lines, as used herein, the term “zero-day data package” refers to a collection (or association) of data (or information) obtained over a zero-day period for generating digital content to surface to one or more user accounts. Specifically, the zero-day data package may include zero-day features and/or metadata associated with a user account, destination-specific identifiers, at least one zero-day score, and/or at least one value-based asset threshold. In one or more embodiments, the zero-day determination system 100 causes one or more matching systems to generate the digital content to surface to the one or more user accounts (including one or more external user accounts associated with the one or more matching systems and/or one or more user accounts within an inter-network facilitation system) based on providing the zero-day data package to the one or more matching systems.

As used herein, the term “identifier derivation engine” refers to a computing system, module, and/or process configured to derive one or more destination-specific identifiers. In particular, the identifier derivation engine can process extracted zero-day features, including the zero-day features that do satisfy a threshold impact on the zero-day score and/or zero-day features that do not satisfy the threshold impact on the zero-day score. Upon processing the extracted zero-day features, the identifier derivation engine may derive (or predict) (e.g., utilizing at least one derivation algorithm) one or more of the destination-specific identifiers (e.g., a subset of the destination-specific identifiers). In some cases, an identifier derivation engine is a component of a zero-day model.

As also used herein, the term “user account” refers to a digital record associated with and uniquely identifying an entity (e.g., an individual, organization, and/or system) within a particular server environment. Specifically, the user account can be associated with an entity that is maintained within a computing environment and includes data (and metadata) relevant to the entity's interactions within that environment. For example, user account can be associated with an entity that is maintained within an inter-network facilitation system. As another example, the user account may be an external user account associated with a third-party server, such as with one or more matching systems at servers external to the inter-network facilitation system.

As additionally used herein, the term “matching system” refers to a third-party computing system, operating on servers external to an inter-network facilitation system, that determines matching user accounts based on a zero-day data package. In one or more embodiments, the zero-day determination system 100 causes one or more matching systems to determine (or identify) that one or more user accounts satisfy a threshold similarity relative to a user account within the inter-network facilitation system. Upon making this determination, the zero-day determination system 100 can cause the one or more matching systems to generate digital content to surface to the one or more user accounts based on providing, to the one or more matching systems, a zero-day data package associated with the user account within the inter-network facilitation system.

As further used herein, the term “direct-asset-transfer account” refers to an account within the inter-network facilitation system that is configured to receive, store, and/or facilitate the direct transfer of assets from an external source (e.g., on a repeated basis without instigation by the user account for each transfer instance). In particular, the direct-asset-transfer account can receive, store, and/or facilitate the transfer of assets to and/or from an external source, such as through an automated or user-authorized transaction process. For example, the direct-asset-transfer account can be linked to one or more external asset institutions, asset networks, and/or asset sources to enable the seamless deposit, withdrawal, and/or redistribution of assets in accordance with predefined transaction protocols.

Moreover, as used herein, the term “data drift” refers to a change in a statistical property of data (e.g., extracted features) over time that can affect the performance, reliability, and/or accuracy of a model, system, and/or decision-making process. Specifically, data drift can include a deviation in input data relative to an expected baseline or a deviation in an output feature relative to an expected baseline. In some cases, the zero-day determination system 100 may monitor one or more zero-day models to detect one or more data drifts. Further, based on detecting a data drifts, the zero-day determination system 100 may modify a zero-day model to account for the data drift, such as by modifying or removing a variable the zero-day model (or from input data processed by the zero-day model) and/or adjusting parameters of (e.g., fine-tuning) the zero-day model.

As used herein, the term “machine learning model” refers to a computer algorithm or a collection of computer algorithms that automatically improve for a particular task through iterative outputs or predictions based on use of data. For example, machine learning model can utilize one or more learning techniques to improve in accuracy and/or effectiveness. Example machine learning models include various types of neural networks, decision trees, gradient boosted trees, support vector machines, and Bayesian networks. In some embodiments, the model modification system utilizes a machine learning model in the form of a neural network and/or a large language model.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network. Upon training as described below, such a neural network may become a large language model that generates responses to prompts by interpreting prompt language, accessing additional data from content items, and executing functions indicated by prompts and/or content items.

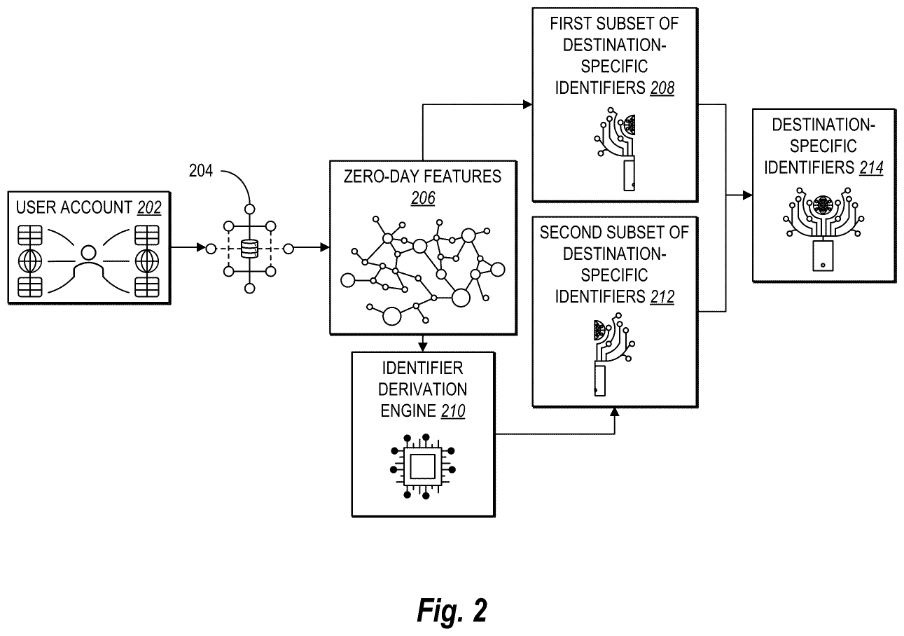

As mentioned above, the zero-day determination system 100 can determine destination-specific identifiers. In particular, the zero-day determination system 100 can extract zero-day features from a plurality of data sources associated with a user account within an inter-network facilitation system 102 and, from the zero-day features, determine the destination-specific identifiers. FIG. 2 illustrates an example diagram of determining destination-specific identifiers from zero-day features in accordance with one or more embodiments.

As illustrated in FIG. 2, the zero-day determination system 100 detects a user account 202 within an inter-network facilitation system 102. To elaborate, the inter-network facilitation system 102 can host or store data for many user accounts of varying types to facilitate access to, transfer of, and other interactions with digital assets among interconnected systems. In some cases, the zero-day determination system 100 detects registration of the user account 202 as a new user account within the inter-network facilitation 102 (e.g., as a new direct-asset-transfer account), while in other cases the zero-day determination system 100 detects a status or type modification of the user account 202, changing from a non-direct-asset-transfer account to a direct-asset-transfer account. In one or more embodiments, the zero-day determination system 100 initiates a zero-day tracker to begin tracking a zero-day period in response to detecting registration (or type change) of the user account 202 (e.g., as a direct-asset-transfer account). The zero-day determination system 100 thus executes the functions and processes described herein within the zero-day period. Additional description regarding user accounts is provided above (e.g., in relation to FIG. 1).

As also illustrated in FIG. 2, the zero-day determination system 100 utilizes a zero-day model 204 to extract zero-day features 206 from a plurality of data sources associated with the user account 202. In particular, the zero-day determination system 100 may utilize the zero-day model 204 to extract the zero-day features 206 within a zero-day period (e.g., within the same day and/or within hours—such as six hours or two hours—of receiving the indication of the initiation of the user account). In one or more embodiments, the zero-day model 204 is a machine learning model, such as a supervised learning model or a neural network (e.g., a deep neural network). Additionally, the zero-day model 204 may be trained, tuned, and/or designed to perform or execute (or to contribute to performing or executing) functions associated with one or more of the zero-day features 206, including extracting the zero-day features 206 from the plurality of data sources. For example, the zero-day model 204 can extract the zero-day features 206 from data sources such as transactional data sources (e.g., asset records, transaction histories, and/or direct asset transfers), behavioral and interaction data sources (e.g., session durations, engagement histories, and/or activity patterns), demographic and profile data sources, communication data sources, and/or external data (e.g., with third-party integrations) associated with the user account 202.

As just mentioned, the zero-day determination system 100 may extract the zero-day features 206. Specifically, the zero-day features 206 can include data points from a plurality of data sources that may describe the user account's interactions, preferences, activities, and/or account-related metadata within (or associated with) the inter-network facilitation system 102. For example, the zero-day features 206 may include direct-asset-transfer account intention events, such as user interactions to initiate a direct-asset transfer account (e.g., during onboarding), a count of ad-selection events submitted or triggered, and/or a count of direct-asset-transfer account forms sent. The zero-day features 206 may also include user profile features, such as pay types (e.g., direct deposit or check), source of income, employment/employer, and/or occupation. Further, the zero-day features 206 may include enrollment and/or acquisition features, such as traffic sources (e.g., referrals), campaign channels (e.g., refer-a-friend), how did you hear about us responses (e.g., from a friend, family member, or co-worker), and/or first path features (e.g., base limit value increases). In some embodiments, the zero-day features 206 include product usage and/or app engagement, such as count of application open events and/or count of direct-asset-transfer account views. In the same or other embodiments, the zero-day features 206 can additionally or alternatively include client device IDs, client device types (and/or versions), user account type(s), interactions with an application and/or web browser, engagement with digital content, transaction history, frequency of logins, saved preferences, browsing activity, geolocation data, demographic information, and/or one or more responses to questions (e.g., response to questions upon initiating the user account 202).

As further illustrated in FIG. 2, the zero-day determination system 100 determines a first subset of destination-specific identifiers 208. In particular, the zero-day determination system 100 can, within the zero-day period, determine that one or more extracted features from the zero-day features 206 satisfy a threshold impact on indicating whether the user account 202 will establish a direct-asset-transfer account within an inter-network facilitation system 102. In some cases, the zero-day determination system 100 makes this determination based on whether the one or more extracted features meets or exceeds a threshold impact on a zero-day score. In at least one embodiment, the zero-day determination system 100 determines that one or more extracted features satisfy the threshold impact by analyzing each extracted feature from the zero-day features 206 to determine how much an extracted feature influences (or will influence) the zero-day score (e.g., by using a predictive score). For example, the zero-day determination system 100 may apply a model (e.g., a machine learning model) and/or statistical methods to determine whether an extracted feature has (or will have) a significant correlation with establishing a direct-asset-transfer account. Extracted features that may increase (and/or decrease) the zero-day score above a predefined threshold may be associated with the first subset of destination-specific identifiers 208.

In the same or other embodiments, the zero-day determination system 100 determines that one or more extracted features satisfy the threshold impact by assigning an importance score and/or predictive weighting (e.g., by using a predictive model, such as a predictive machine learning model) to each extracted feature. If an importance score and/or predictive weighting falls below a predefined threshold, the corresponding extracted feature may be excluded from the first subset of destination-specific identifiers 208.

Additionally, as illustrated in FIG. 2, the zero-day determination system 100 utilizes an identifier derivation engine 210 to derive (or predict) a second subset of destination-specific identifiers 212. Specifically, the identifier derivation engine 210 can be a computing system, module, and/or process configured to derive (or predict) one or more unextracted zero-day features and/or destination-specific identifiers. Indeed, the identifier derivation engine 210 can derive (or predict) the second subset of destination-specific identifiers 212 to account for any non-extracted zero-day features that may have otherwise satisfied the threshold impact if they had been extracted. In at least one embodiment, the zero-day determination system 100 derives (or predicts) the second subset of destination-specific identifiers 212 within the zero-day period.

To elaborate, the identifier derivation engine 210 can process extracted features of the zero-day features 206—including zero-day features that do satisfy the threshold impact on the zero-day score and/or zero-day features that do not satisfy the threshold impact on the zero-day score—within the zero-day period. Based on processing the extracted features, the identifier derivation engine 210 may generate derived zero-day features that were not extracted from the one or more data sources associated with the user account 202 (e.g., as a result of the shortened zero-day period for zero-day feature extraction). For instance, to generate the derived zero-day features, the identifier derivation engine 210 may process extracted features that may include one or more of the zero-day features 206 described above. As an example, the identifier derivation engine 210 may process extracted features like: responses to questions (e.g., response to questions upon initiating the user account 202), a client device ID, a client device type (and/or version), user account type(s), browsing activity, geolocation data, demographic information, an employer, and/or user interactions to initiate a direct-asset transfer account (e.g., during onboarding).

In one or more embodiments, the identifier derivation engine 210 generates, from the processed extracted features, the derived zero-day features that may include one or more of the zero-day features 206 described above. For instance, the identifier derivation engine 210 can generate derived zero-day features like: a direct-asset-transfer account intention event, a pay type, a source of income, an occupation, campaign channels, product usage, and/or engagement with digital content. In the same or other embodiments, the identifier derivation engine 210 can generate one or more derived zero-day features that may not include one or more of the zero-day features 206 described above.

In one or more embodiments, the zero-day determination system 100 may determine (and/or derive or predict) the second subset of destination-specific identifiers 212 based on the derived zero-day features. For instance, the zero-day determination system 100 determines that one or more of the derived zero-day features satisfy a threshold impact on indicating whether the user account 202 will establish a direct-asset-transfer account within an inter-network facilitation system. In some cases, the zero-day determination system 100 makes this determination based on whether the one or more derived zero-day features meets or exceeds a threshold impact on a zero-day score. In at least one embodiment, the zero-day determination system 100 determines that one or more derived zero-day features satisfy the threshold impact in a similar manner to that described above in relation to whether the one or more extracted features meets or exceeds a threshold impact.

As shown in FIG. 2, the zero-day determination system 100 determines the destination-specific identifiers 214. In particular, the destination-specific identifiers 214 can include at least one feature specific to one or more matching systems at servers external to the inter-network facilitation system. In at least one embodiment, the zero-day determination system 100 determines the destination-specific identifiers 214 by combining (or associating) the first subset of destination-specific identifiers 208 and the second subset of destination-specific identifiers 212. Additionally, in some cases, the zero-day determination system 100 determines the destination-specific identifiers 214 in a zero-day period. Moreover, the zero-day determination system 100 may determine a plurality of sets of destination-specific identifiers that can each be directed to specific matching systems.

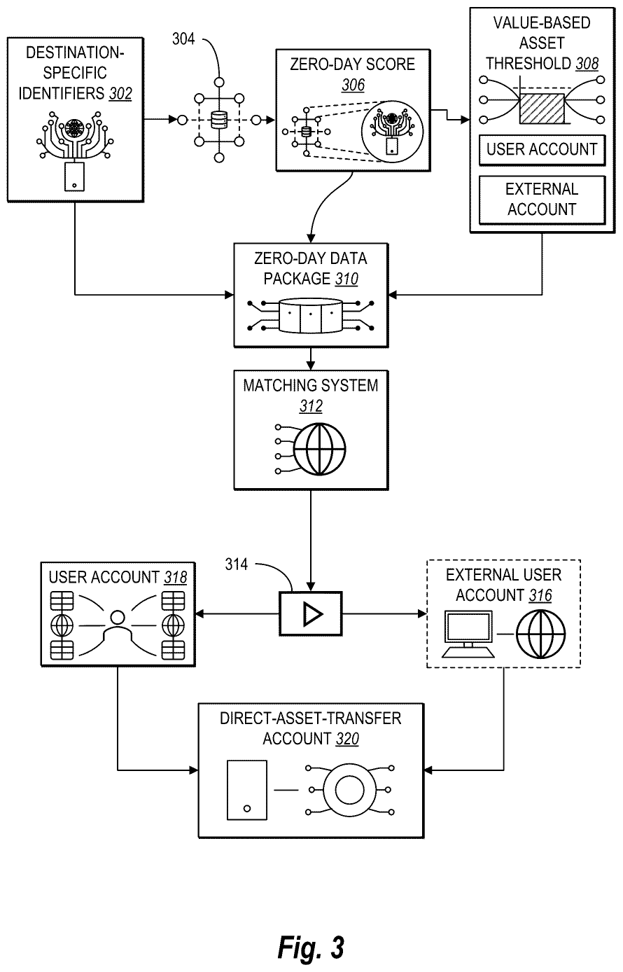

As expressed above, the zero-day determination system 100 can provide a zero-day data package to one or more matching systems. In particular, the zero-day determination system 100 can generate the zero-day data package by collecting (or combining or associating) destination-specific identifiers, a zero-day score, and/or a value-based asset threshold. FIG. 3 illustrates an example diagram of generating a zero-day data package for direct-asset-transfer accounts in accordance with one or more embodiments.

As illustrated in FIG. 3, and as described above, the zero-day determination system 100 can determine destination-specific identifiers 302 for a user account (e.g., a direct-asset-transfer account) within an inter-network facilitation system. In particular, the zero-day determination system 100 can determine the destination-specific identifiers 302 from zero-day features. For example, the zero-day determination system 100 can determine the destination-specific identifiers 302 as described in greater detail above in relation to FIG. 2.

As also illustrated in FIG. 3, the zero-day determination system 100 can utilize a zero-day model 304 to generate a zero-day score 306. In particular, the zero-day determination system 100 may utilize the zero-day model 304 to generate the zero-day score 306 within a zero-day period (e.g., within the same day and/or within hours—such as six hours or two hours—of receiving the indication of the initiation of the user account). In one or more embodiments, the zero-day model 304 is a machine learning model, such as a supervised learning model or a neural network (e.g., a deep neural network). Additionally, the zero-day model 304 may be trained, tuned, and/or designed to perform or execute (or to contribute to performing or executing) functions associated with one or more zero-day features, including generating the zero-day score 306.

To elaborate, the zero-day model 304 can receive and/or process the destination-specific identifiers 302 (and/or zero-day features). Based on the destination-specific identifiers 302 (and/or the zero-day features), the zero-day model 304 can generate the zero-day score 306. In at least one embodiment, the zero-day score 306 indicates a likelihood of the user account establishing a direct-asset-transfer account within an inter-network facilitation system 102. For example, the zero-day score 306 may indicate a likelihood of the user account establishing the direct-asset-transfer account within the inter-network facilitation system 102 within a specific timeframe (e.g., 30 days). In the same or other embodiments, the zero-day score 306 also indicates one or more additional or alternative considerations, such as future lifetime value. In some cases, the zero-day determination system 100 may generate a plurality of zero-day scores (e.g., for a plurality of matching systems) based on the destination-specific identifiers 302 (and/or the zero-day features).

As further illustrated in FIG. 3, the zero-day determination system 100 determines a value-based asset threshold 308. In particular, based on the zero-day score 306, the zero-day determination system 100 can determine the value-based asset threshold 308 for generating digital content to surface to user accounts. For example, the zero-day determination system 100 the zero-day determination system 100 determines the value-based asset threshold 308 for generating digital content to surface (or distribute) to one or more user accounts at one or more matching systems and/or to one or more user accounts at the inter-network facilitation system 102. In some instances, the zero-day determination system 100 determines a plurality of value-based asset thresholds (e.g., for a plurality of matching systems) based on the zero-day score 306.

Additionally, as illustrated in FIG. 3, the zero-day determination system 100 generate a zero-day data package 310. Specifically, the zero-day determination system 100 can generate the zero-day data package 310 by collecting (or associating or combining) the destination-specific identifiers 302, the zero-day score 306, and/or the value-based asset threshold 308. In additional or alternative embodiments, the zero-day data package 310 may also include metadata and/or zero-day features associated with the user account. In some implementations, the zero-day data package 310 can include a plurality of zero-day scores and/or value-based asset thresholds. Further, the zero-day determination system 100 may generate a plurality zero-day data packages associated with the user account for the same matching system and/or for a plurality of matching systems (e.g., within a twenty-four-hour period).

As shown in FIG. 3, the zero-day determination system 100 causes a matching system 312 to surface digital content 314 to one or more additional user accounts. In particular, upon generating the zero-day data package 310, the zero-day determination system 100 can provide the zero-day data package 310 to the matching system 312. In some cases, the zero-day determination system 100 may provide a plurality (e.g., two or three) of zero-day packages associated with the user account to one or more matching systems (e.g., including the matching system 312) within a twenty-four-hour period. Based on providing the zero-day data package to the matching system 312, the zero-day determination system 100 can cause the matching system 312 to generate and/or surface (or provide) the digital content 314 to the one or more additional user accounts. By providing the zero-day data package 310 to the matching system 312, the zero-day determination system 100 leverages the matching capabilities of the matching system 312 to detect or identify one or more other user accounts that have features similar (e.g., based on satisfying a threshold similarity) to those of the user account corresponding to the zero-day score 306 (and/or the destination-specific identifiers 302 and/or the value-based asset threshold 308). Indeed, provided that the user account is a direct-asset-transfer account, the zero-day determination system 100 can use the matching system 312 as a proxy engine to identify (and surface the digital content 314 to) the one or more additional user accounts with at least a threshold likelihood of becoming direct-asset-transfer accounts. In one or more embodiments, the zero-day determination system 100 also causes a plurality of matching systems to surface digital content to one or more additional user accounts (e.g., based on a plurality of zero-day data packages). Further, in the same or other embodiments, the digital content 314 is specific to a direct-asset-transfer account 320, one or more matching systems, and/or to different destination-specific identifiers (e.g., destination-specific identifiers 302) provided to the one or more matching systems.

In at least one embodiment, the zero-day determination system 100 may generate and/or provide the digital content 314. In particular, the zero-day determination system 100 may generate the digital content 314 and/or provide the digital content 314 to the matching system 312 (and/or to a plurality of matching systems) for distribution. Indeed, the zero-day determination system 100 can generate specific digital content tailored to a particular matching system, to a specific zero-day score, and/or to a particular set of destination-specific identifiers. The zero-day determination system 100 can further include the digital content 314 as part of a zero-day package (in addition to other components described herein). In some cases, the zero-day determination system 100 may surface the digital content 314 to the one or more additional user accounts (e.g., without causing the one or more matching systems to do so).

In one or more embodiments, the zero-day determination system 100 can cause one or more matching systems to surface (or provide) the digital content 314 to one or more additional user accounts at a corresponding matching system and/or to one or more additional user accounts at the inter-network facilitation system 102. For example, the zero-day determination system 100 can cause the matching system 312 to surface the digital content 314 to an external user account 316 associated with the matching system 312. As another example, the zero-day determination system 100 can cause the matching system 312 to surface the digital content 314 to a user account 318 associated with the inter-network facilitation system 102. In at least one embodiment, the zero-day determination system 100 causes the matching system 312 to generate the digital content 314 according to the value-based asset threshold 308 so that, for example, the value of the digital content 314 does not exceed that value associated with the value-based asset threshold 308.

As also shown in FIG. 3, the zero-day determination system 100 can initiate (or generate) a direct-asset-transfer account 320 within the inter-network facilitation system 102 for the one or more additional user accounts. Specifically, the zero-day determination system 100 can change or update a user account within the inter-network facilitation system 102 from a non-direct-asset-transfer account to a direct-asset-transfer account 320. For example, the zero-day determination system 100 can, upon causing the digital content 314 to be surfaced (or upon surfacing the digital content 314), receive an indication (e.g., based on monitoring interaction data) that a subset of user accounts—which includes at least one user account (e.g., the external user account 316 and/or the user account 318)—has received, interacted with, and/or viewed the digital content 314. In at least one embodiment, the zero-day determination system 100 can receive an indication of (and/or facilitate) one or more user accounts of the subset of user accounts) initiating (or registering) to change or update their accounts within the inter-network facilitation system 102 from a non-direct-asset-transfer account to a direct-asset-transfer account 320. In the same or other embodiments, the digital content 314 may include one or more elements selectable (e.g., on a graphical user interface or GUI of a client device) to initiate (or generate) the direct-asset-transfer account 320 within the inter-network facilitation system 102.

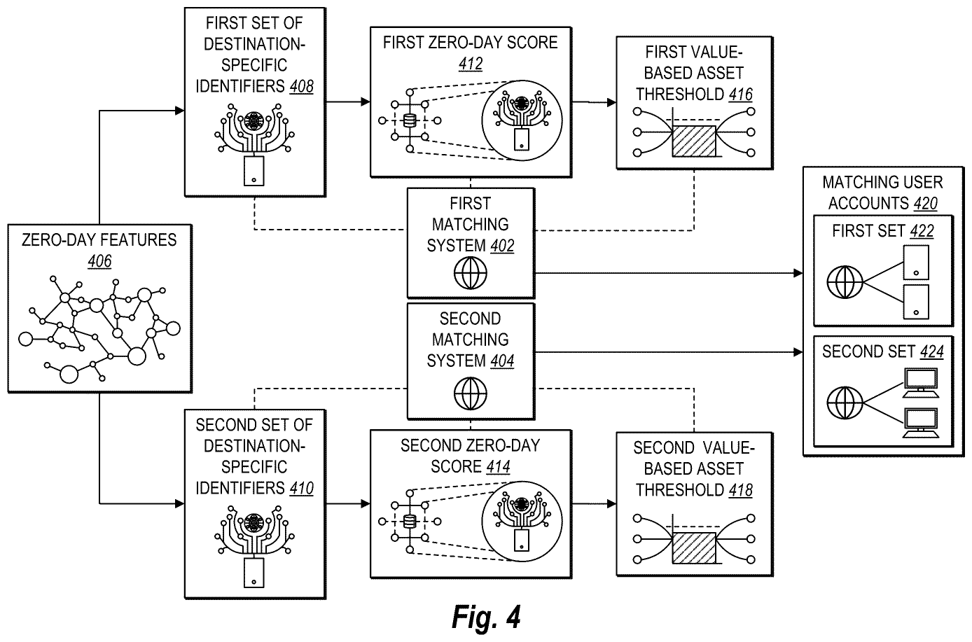

As expressed above, the zero-day determination system 100 can cause one or more matching systems to surface digital content to one or more user accounts. In particular, the zero-day determination system 100 can generate a plurality of zero-day data packages intended for causing particular matching systems to surface the digital content to particular sets of matching user accounts. FIG. 4 illustrates an example diagram of causing a first matching system to generate digital content to surface to a first set of matching user accounts and a second matching system to generate digital content to surface to a second set of matching user accounts in accordance with one or more embodiments.

As illustrated in FIG. 4, the zero-day determination system 100 can determine a first set of destination-specific identifiers 408 specific to a first matching system 402 and a second set of destination-specific identifiers 410 specific to a second matching system 404. In particular, the zero-day determination system 100 can utilize one or more zero-day models to extract zero-day features 406 from one or more data sources associated with a user account within an inter-network facilitation system 102. From the zero-day features 406, the zero-day determination system 100 can determine both the first set of destination-specific identifiers 408 and the second set of destination-specific identifiers 410. In at least one embodiment, the first set of destination-specific identifiers 408 include features from the zero-day features 406 specific to the first matching system 402. In the same or other embodiments, the second set of destination-specific identifiers 410 include features from the zero-day features 406 specific to the second matching system 404.

As also illustrated above, the zero-day determination system 100 may generate a first zero-day score 412 specific to the first matching system 402 and a second zero-day score 414 specific to the second matching system 404. Specifically, the zero-day determination system 100 can generate the first zero-day score 412 based on utilizing the one or more zero-day models to process the first set of destination-specific identifiers 408. Similarly, the zero-day determination system 100 may generate the second zero-day score 414 based on utilizing the one or more zero-day models to process the second set of destination-specific identifiers 410.

As further illustrated in FIG. 4, the zero-day determination system 100 can determine a first value-based asset threshold 416 specific to the first matching system 402 and a second value-based asset threshold 418 specific to the second matching system 404. In particular, the zero-day determination system 100 can determine the first value-based asset threshold 416 based on the first zero-day score 412. Similarly, the zero-day determination system 100 can determine the second value-based asset threshold 418 based on the second zero-day score 414.

In one or more embodiments, the zero-day determination system 100 can provide a first zero-day data package to the first matching system 402. For instance, the zero-day determination system 100 can generate the first data package by collecting (or associating or combining) the first set of destination-specific identifiers 408, the first zero-day score 412, the first value-based asset threshold 416, and/or metadata and/or the zero-day features 406 associated with the user account. Upon generating the first zero-day data package, the zero-day determination system 100 can provide the first zero-day data package to the first matching system 402 to cause the first matching system 402 to generate digital content to surface (or provide) to matching user accounts 420. As an example, the zero-day determination system 100 can cause the first matching system 402 to surface the digital content to a first set of matching user accounts 422. In one or more embodiments, the first set of matching user accounts 422 includes one or more other user accounts that zero-day determination system 100 had detected or identified as having features similar to those of the user account corresponding to the first zero-day score 412 (and/or the first set of destination-specific identifiers 408 and/or the first value-based asset threshold 416).

In the same or other embodiments, the zero-day determination system 100 can provide a second zero-day data package to the second matching system 404. For instance, the zero-day determination system 100 can generate the second data package by collecting (or associating or combining) the second set of destination-specific identifiers 410, the second zero-day score 414, the second value-based asset threshold 418, and/or the metadata and/or the zero-day features 406 associated with the user account. Upon generating the second zero-day data package, the zero-day determination system 100 can provide the second zero-day data package to the second matching system 404 to cause the second matching system 404 to generate digital content to surface (or provide) to the matching user accounts 420. For example, the zero-day determination system 100 can cause the second matching system 404 to surface the digital content to a second set of matching user accounts 424. In one or more embodiments, the second set of matching user accounts 424 includes one or more other user accounts that zero-day determination system 100 detected or identified as having features similar to those of the user account corresponding to the second zero-day score 414 (and/or the second set of destination-specific identifiers 410 and/or the second value-based asset threshold 418).

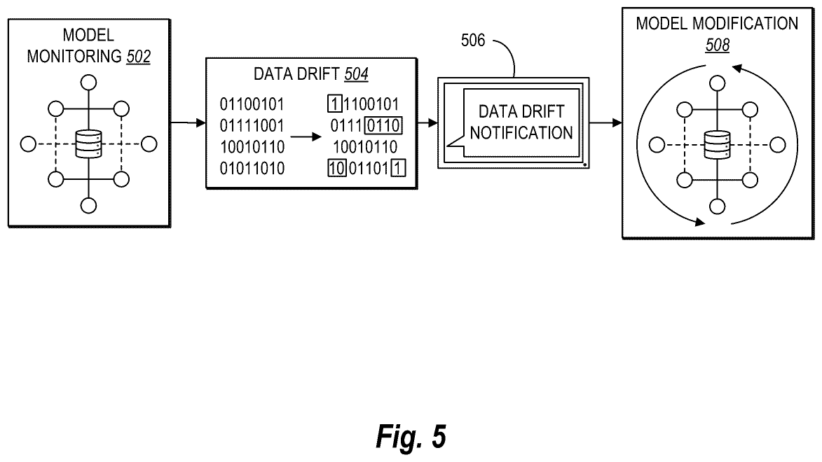

As expressed above, the zero-day determination system 100 may modify a zero-day model to account for data drift. In particular, the zero-day determination system 100 can detect a data draft in input data and/or in an output feature and modify the zero-day model to account for the data drift. FIG. 5 illustrates an example diagram of monitoring a zero-day model to detect a data drift and modifying the zero-day model to account for the data draft in accordance with one or more embodiments.

As illustrated in FIG. 5, the zero-day determination system 100 performs the act 502 of monitoring one or more zero-day models to detect a data drift 504. In particular, the zero-day determination system 100 can monitor input data and/or output features to detect the data drift 504. For example, the zero-day determination system 100 performs the act 502 at the point in time of modeling and/or when the zero-day determination system 100 generates and/or provides a zero-day data package or any portion of the zero-day data package. In some instances, the zero-day determination system 100 can detect a plurality of data drifts (e.g., one or more deviations in input data and/or one or more deviations in output features) from a single zero-day model and/or from a plurality of zero-day models. Further, in one or more embodiments, the zero-day determination system 100 utilizes a drift detection model to perform the act 502.

In at least one embodiment, the zero-day determination system 100 may perform the act 502 in real time. To elaborate, the zero-day determination system 100 can monitor predicted output features simultaneously (or contemporaneously in tandem with) gathering or analysis of input data, such as raw observed data provided to a zero-day model to generate the predicted output features (e.g., zero-day features). Accordingly, the zero-day determination system 100 may detect the data drift 504 when anomalies begin to occur in output zero-day features that shift or change dramatically (e.g., beyond a threshold amount) from previously generated zero-day features for the same user account or for a similar user account. The zero-day determination system 100 can thus detect a data drift 504 that may be resulting from environmental changes or systemic changes resulting in different raw observed data.

As just mentioned, the zero-day determination system 100 may monitor input data to detect the data drift 504. For example, the data drift 504 can be a deviation in input data relative to an expected baseline. To elaborate, the zero-day determination system 100 can track data that is input into a zero-day model and can compare the input data to an expected baseline (e.g., historical norms). In one or more embodiments, the zero-day determination system 100 detects the deviation in input data by using statistical methods (or tests) to compare past and present feature distributions, determining that data (or features) that were previously highly predictive now have little impact on generating a zero-day score, and/or by detecting if data (or a feature) changes beyond a predefined threshold.

As mentioned above, the zero-day determination system 100 can monitor output features to detect the data drift 504. For instance, the data drift 504 can be a deviation in an output feature (or features) relative to an expected baseline. To elaborate, the zero-day determination system 100 can monitor changes in zero-day model output features, destination-specific identifiers, zero-day scores, and/or value-based asset thresholds to ensure that the outputs remain consistent with an expected baseline (e.g., historical expectations). In at least one embodiment, the zero-day determination system 100 detects the deviation in an output feature by using predicted vs. actual discrepancy monitoring (e.g., comparing model predictions against actual outcomes over time), detecting a drift in confidence scores as to the output features, and/or by detecting if an output feature changes beyond a predefined threshold.

As also illustrated in FIG. 5, the zero-day determination system 100 performs the act 506 of providing, for display in a graphical user interface (GUI) of a client device, a data drift notification. In particular, the zero-day determination system 100 may perform the act 506 to indicate the data drift 504 (and/or one or more other data drifts). In some embodiments, the zero-day determination system 100 may provide one or more elements selectable to modify the one or more zero-day models to account for the data drift 504. In the same or other embodiments, the zero-day determination system 100 automates modifying of the zero-day model upon detecting the data drift 504 (e.g., with or without providing the one or more elements).

As further illustrated in FIG. 5, the zero-day determination system 100 performs the act 508 of modifying the one or more zero-day models to account for the data drift 504. Specifically, the zero-day determination system 100 may perform the act 508 by, for example, modifying or removing one or more variables of the one or more zero-day models, adjusting parameters of (e.g., finetuning) the one or more zero-day models, reweighting features (e.g., adjusting feature importance), and/or retraining the one or more zero-day models. In some instances, the zero-day determination system 100 identifies the cause of the data drift 504. If the cause is transitory, the zero-day determination system 100 may ignore the data drift 504 until the data stabilizes and/or until a threshold period of time has elapsed. If the cause is not transitory, the zero-day determination system 100 may perform the act 508 as just described.

In one or more embodiments, the zero-day determination system 100 modifies the one or more zero-day models based on receiving (or detecting) a user interaction with the client device, such as with the one or more elements. In the same or other embodiments, the zero-day determination system 100 may additionally or alternatively automate modifying of the zero-day model, for example, without receiving (or detecting) a user interaction with the client device. Consequently, by monitoring for data shifts (e.g., the data drift 504) and modifying the one or more zero-day models based on the data shifts, the zero-day determination system 100 can advantageously adapt to unexpected shifts in data patterns and/or to rapid or unpredictable changes, such as sudden real-world disruptions (like policy changes or global events) or shifts in user behavior, regional market trends, and/or external economic conditions.

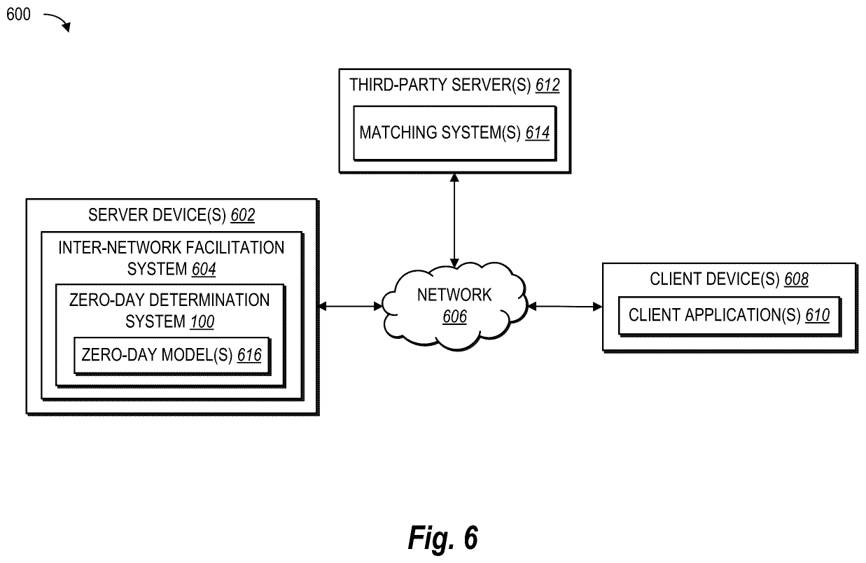

In some embodiments, the zero-day determination system 100 is part of a networking environment. For example, FIG. 6 illustrates a diagram of an example environment in which the zero-day determination system 100 can operate in accordance with one or more embodiments.

As shown in FIG. 6, system 600 includes server device(s) 602 (which includes inter-network facilitation system 604, the zero-day determination system 100, and zero-day model(s) 616), client device(s) 608, and third-party server(s) 612. As further illustrated in FIG. 6, the server device(s) 602, the client device(s) 608, and the third-party server(s) 612 can communicate via the network 606.

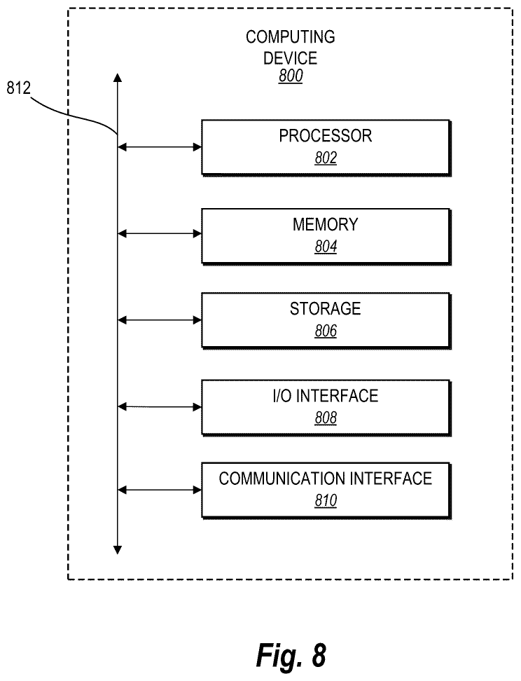

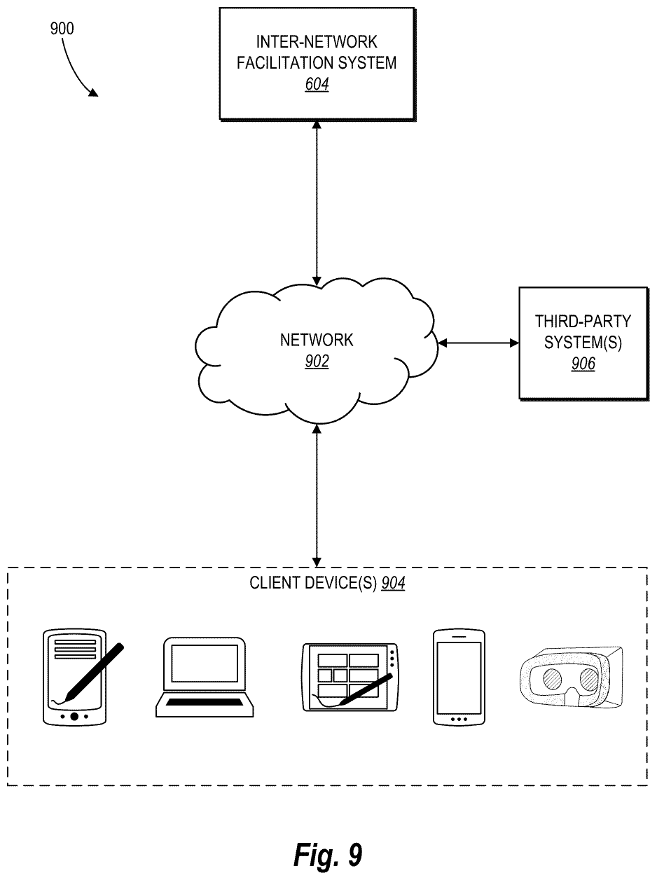

Although FIG. 6 illustrates the zero-day determination system 100 being implemented by a particular component and/or device within system 600, the zero-day determination system 100 can be implemented, in whole or in part, by other computing devices and/or components within the system 600 (e.g., the client device(s) 608). Additional description regarding the illustrated computing devices (e.g., the server device(s) 602, computing devices implementing the zero-day determination system 100, the client device(s) 608, and/or the network 606) is provided with respect to FIGS. 8-9 below.

As shown in FIG. 6, the server device(s) 602 can include the inter-network facilitation system 604 (e.g., the inter-network facilitation system 102). In some embodiments, the inter-network facilitation system 604 can determine, store, generate, and/or display financial information and/or other asset information corresponding to a user (or a client) account (e.g., in a banking application or a money transfer application). Furthermore, the inter-network facilitation system 604 can also electronically communicate (or facilitate) financial transactions between one or more user (or client) accounts (and/or computing devices). Moreover, the inter-network facilitation system 604 can also track and/or monitor financial transactions and/or financial transaction behaviors of a user (or a client) within a user (or a client) account.

The inter-network facilitation system 604 can include a system that comprises the zero-day determination system 100 and/or the zero-day model(s) 616 and that facilitates financial transactions and digital communications across different computing systems over one or more networks. For example, the inter-network facilitation system 604 manages asset accounts (e.g., direct-asset-transfer accounts, secured accounts, and/or other accounts) for one or more accounts registered within the inter-network facilitation system 604. In some cases, the inter-network facilitation system 604 is a centralized network system that facilitates access to asset accounts (e.g., direct-asset-transfer accounts, secured accounts, and/or other accounts) within a central network location. Indeed, the inter-network facilitation system 604 can link accounts from different network-based financial institutions to provide information regarding, and management tools for, the different accounts. Additional description regarding the zero-day model(s) 616 is provided above (e.g., in relation to previous figures).

As also illustrated in FIG. 6, system 600 includes the client device(s) 608. For example, the client device(s) 608 may include, but are not limited to, mobile devices (e.g., smartphones, tablets) or other types of computing devices, including those explained below with reference to FIGS. 8-9. Additionally, the client device(s) 608 can include computing devices associated with (and/or operated by) user accounts for the inter-network facilitation system 604. Moreover, system 600 can include various numbers of client devices that communicate and/or interact with the inter-network facilitation system 604 and/or the zero-day determination system 100.

Furthermore, as shown in FIG. 6, the client device(s) 608 can include client application(s) 610. Client application(s) 610 can include instructions that (upon execution) cause the client device(s) 608 to perform various actions. For example, a user of a user account can interact with client application(s) 610 on client device(s) 608 to initiate a user account, access financial (or asset) information, manage finances (or assets), initiate a financial transaction (e.g., transfer money to another account, deposit money, withdraw money), and/or access or provide data (to the server device(s) 602). Furthermore, in one or more implementations, the client application(s) 610 can display one or more graphical user interfaces from which the zero-day determination system 100 can receive and display information regarding network transactions.

In certain instances, the client device(s) 608 corresponds to one or more user accounts (e.g., user accounts stored at the server device(s) 602). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device but any device corresponding to a user account of a particular user. Accordingly, in using the term client device, this disclosure can refer to any computing device corresponding to a user account of the inter-network facilitation system 604.

As illustrated in FIG. 6, system 600 includes third-party server(s) 612. In one or more embodiments, the third-party server(s) 612 facilitates seamless data exchange of data associated with a third-party entity and/or a client (or user) between third-party platform(s) and the inter-network facilitation system 604 and/or the zero-day determination system 100. For instance, the third-party server(s) 612 enables the inter-network facilitation system 604 and/or the zero-day determination system 100 to receive, access, process, and/or store (e.g., in one or more data repositories) data associated with a third-party entity and/or a client from the third-party platform(s). In some instances, the data associated with the third-party entity and/or the client includes data specific to third-party matching systems (e.g., destination-specific identifiers and/or destination-specific digital content). As illustrated, third-party server(s) 612 can be located on a separate server. In some cases, the third-party server(s) 612 can be integrated or included in the zero-day determination system 100 or the inter-network facilitation system 604. Further, matching system(s) 614 (as explained in greater detail above) may operate (and/or be located) on the third-party server(s) 612.

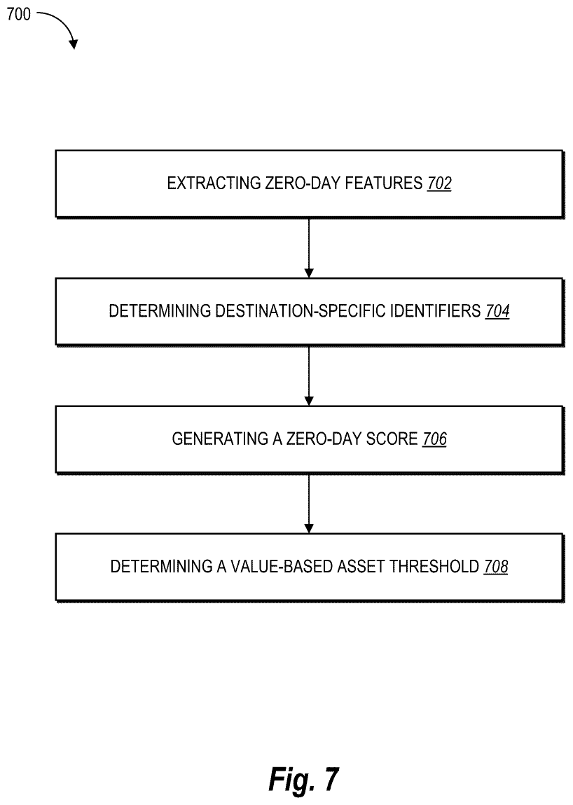

As further shown in FIG. 6, the system 600 includes the network 606. As mentioned above, the network 606 can enable communication between components of the system 600. In one or more embodiments, the network 606 may include a suitable network and may communicate using a various number of communication platforms and technologies suitable for transmitting data and/or communication signals, examples of which are described with reference to FIG. 7. Furthermore, although FIG. 6 illustrates the server device(s) 602, the client device(s) 608, and the third-party server(s) 612 communicating via the network 606, the various components of the system 600 can communicate and/or interact via other methods (e.g., the server device(s) 602 and the client device(s) 608 can communicate directly).

FIGS. 1-6, the corresponding text, and the examples provide a number of different systems and methods for generating destination-specific identifiers and determining a value-based asset threshold. In addition to the foregoing, implementations can also be described in terms of flowcharts comprising acts steps in a method for accomplishing a particular result. For example, FIG. 7 illustrates an example flowchart of a series of acts for determining a value-based asset threshold in accordance with one or more embodiments. While FIG. 7 illustrates acts according to certain implementations, alternative implementations may omit, add to, reorder, and/or modify any of the acts shown in FIG. 7. The acts of FIG. 7 can be performed as part of a method. Alternatively, a non-transitory computer readable medium can comprise instructions that, when executed by one or more processors, cause a computing device to perform the acts of FIG. 7. In still further implementations, a system can perform the acts of FIG. 7. Additionally, the acts described herein may be repeated or performed in parallel with one another or in parallel with different instances of the same or other similar acts.

As illustrated in FIG. 7, the series of acts 700 may include an act 702 of extracting zero-day features. In particular, the act 702 involves extracting, utilizing a zero-day model of an inter-network facilitation system, zero-day features from a plurality of data sources associated with a user account within the inter-network facilitation system. The series of acts 700 can also include an act 704 of determining destination-specific identifiers. In particular, the act 704 can involve determining, from the zero-day features, destination-specific identifiers comprising features specific to one or more matching systems at servers external to the inter-network facilitation system. Additionally, the series of acts 700 can include an act 706 of generating a zero-day score. In particular, the act 706 can involve generating, utilizing the zero-day model to process the destination-specific identifiers for the user account, a zero-day score indicating a likelihood of the user account establishing a direct-asset-transfer account within the inter-network facilitation system. Further, the series of acts 700 can include the act 708 of determining a value-based asset threshold. In particular, the act 708 can involve, determining, based on the zero-day score, a value-based asset threshold for generating digital content to surface to user accounts.

In some embodiments, the series of acts 700 includes an act of determining the destination-specific identifiers by: determining, from the zero-day features, a first subset of the destination-specific identifiers comprising zero-day features that satisfy a threshold impact on the zero-day score; deriving, utilizing an identifier derivation engine to process the zero-day features comprising a subset of zero-day features that do not satisfy the threshold impact on the zero-day score, a second subset of the destination-specific identifiers that satisfy the threshold impact on the zero-day score; and combining the first subset of the destination-specific identifiers and the second subset of the destination-specific identifiers. The series of acts 700 can also include an act of extracting the zero-day features from the plurality of data sources by extracting, utilizing the zero-day model, the zero-day features within a zero-day period upon receiving an indication of an initiation of the user account.

In some embodiments, the series of acts 700 includes an act of generating, utilizing the zero-day model to process a first set of destination-specific identifiers for a first matching system external to the inter-network facilitation system, a first zero-day score specific to the first matching system; and generating, utilizing the zero-day model to process a second set of destination-specific identifiers for a second matching system external to the inter-network facilitation system, a second zero-day score specific to the second matching system. In the same or other embodiments, the series of acts 700 includes an act of providing the first zero-day score to the first matching system to cause the first matching system to generate digital content to surface to a first set of matching user accounts; and providing the second zero-day score to the second matching system to cause the second matching system to generate digital content to surface to a second set of matching user accounts.

In one or more embodiments, the series of acts 700 includes an act of causing the one or more matching systems to generate digital content to surface to at least one external user account associated with the one or more matching systems based on providing, to the one or more matching systems, a zero-day data package comprising the destination-specific identifiers, the zero-day score, and the value-based asset threshold. The series of acts 700 can also include an act of monitoring the zero-day model to detect a data drift comprising a deviation in input data relative to an expected baseline or a deviation in an output feature relative to an expected baseline; providing, for display on a client device, a data drift notification indicating the data drift; and modifying the zero-day model to account for the data drift by removing a variable from the input data processed by the zero-day model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 (e.g., the server device(s) 602, the client device(s) 608, and/or the third-party server(s) 612) that may be configured to perform one or more of the processes described above. One will appreciate that one or more computing devices, such as the computing device 800 may represent the computing devices described above (e.g., computing device 800, server device(s) 602, client device(s) 608). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

FIG. 9 illustrates an example network environment 900 of the inter-network facilitation system 604 (e.g., the inter-network facilitation system 102). The network environment 900 includes client device(s) 904 (e.g., client device(s) 608), an inter-network facilitation system 604, and third-party system(s) 906 connected to each other by network 902. Although FIG. 9 illustrates a particular arrangement of the client device(s) 904, the inter-network facilitation system 604, the third-party system(s) 906, and the network 902, this disclosure contemplates any suitable arrangement of the client device(s) 904, the inter-network facilitation system 604, the third-party system(s) 906, and the network 902. As an example, and not by way of limitation, two or more of the client device(s) 904, the inter-network facilitation system 604, and the third-party system(s) 906 communicate directly, bypassing the network 902. As another example, two or more of the client device(s) 904, the inter-network facilitation system 604, and the third-party system(s) 906 may be physically or logically co-located with each other in whole or in part.

Moreover, although FIG. 9 illustrates a particular number of the client device(s) 904, the inter-network facilitation system 604, the third-party system(s) 906, and the network 902, this disclosure contemplates any suitable number of the client device(s) 904, inter-network facilitations systems, the third-party system(s) 906, and the network 902. As an example, and not by way of limitation, network environment 900 may include multiple client devices, inter-network facilitation systems, third-party systems, and/or networks.

This disclosure contemplates any suitable network for the network 902. As an example, and not by way of limitation, one or more portions of the network 902 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 902 may include one or more networks.

Links may connect the client device(s) 904, inter-network facilitation system 604 (e.g., which hosts the zero-day determination system 100), and the third-party system(s) 906 to the network 902 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device(s) 904 may be an electronic device including hardware, software, or embedded logic components or a combination of two or more such components and capable of carrying out the appropriate functionalities implemented or supported by the client device(s) 904. As an example, and not by way of limitation, the client device(s) 904 may include any of the computing devices discussed above in relation to FIG. 9. The client device(s) 904 may enable a network user at the client device(s) 904 to access the network 902. The client device(s) 904 may enable its user to communicate with other users at other client devices of the client device(s) 904.

In particular embodiments, the client device(s) 904 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device(s) 904 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device(s) 904 one or more Hyper Text Markup Language (“HTML”) files responsive to the HTTP request. The client device(s) 904 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 604 may be a network-addressable computing system that can interface between two or more computing networks or servers associated with different entities such as financial institutions (e.g., banks, credit processing systems, ATM systems, or others). In particular, the inter-network facilitation system 604 can send and receive network communications (e.g., via the network 902) to link the third-party system(s) 906. For example, the inter-network facilitation system 604 may receive authentication credentials from a user to link the third-party system(s) 906 such as an online bank account, credit account, debit account, or other financial account to a user account within the inter-network facilitation system 604. The inter-network facilitation system 604 can subsequently communicate with the third-party system(s) 906 to detect or identify balances, transactions, withdrawal, transfers, deposits, credits, debits, or other transaction types associated with the third-party system(s) 906. The inter-network facilitation system 604 can further provide the aforementioned or other financial information associated with the third-party system(s) 906 for display via the client device(s) 904. In some cases, the inter-network facilitation system 604 links more than one of the third-party system(s) 906, receiving account information for accounts associated with each respective third-party system of the third-party system(s) 906 and performing operations or transactions between the different systems via authorized network connections.

In particular embodiments, the inter-network facilitation system 604 may interface between an online banking system and a credit processing system via the network 902. For example, the inter-network facilitation system 604 can provide access to a bank account of the third-party system(s) 906 and linked to a user account within the inter-network facilitation system 604. Indeed, the inter-network facilitation system 604 can facilitate access to, and transactions to and from, the bank account of the third-party system(s) 906 via a client application of the inter-network facilitation system 604 on the client device(s) 904. The inter-network facilitation system 604 can also communicate with a credit processing system, an ATM system, and/or other financial systems (e.g., via the network 902) to authorize and process credit charges to a credit account, perform ATM transactions, perform transfers (or other transactions) across accounts of different third-party systems of the third-party system(s) 906, and to present corresponding information via the client device(s) 904.

In particular embodiments, the inter-network facilitation system 604 includes a model for approving or denying transactions. For example, the inter-network facilitation system 604 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 604 and/or the third-party system(s) 906), the inter-network facilitation system 604 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 604 may be accessed by the other components of network environment 900 either directly or via the network 902. In particular embodiments, the inter-network facilitation system 604 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 604 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device(s) 904, or an inter-network facilitation system 604 to manage, retrieve, modify, add, or delete, the information stored in a data store.

In particular embodiments, the inter-network facilitation system 604 may provide users with the ability to take actions on various types of items or objects, supported by the inter-network facilitation system 604. As an example, and not by way of limitation, the items and objects may include financial institution networks for banking, credit processing, or other transactions, to which users of the inter-network facilitation system 604 may belong, computer-based applications that a user may use, transactions, interactions that a user may perform, or other suitable items or objects. A user may interact with anything that is capable of being represented in the inter-network facilitation system 604 or by an external system of a third-party system, which is separate from inter-network facilitation system 604 and coupled to the inter-network facilitation system 604 via the network 902.

In particular embodiments, the inter-network facilitation system 604 may be capable of linking a variety of entities. As an example, and not by way of limitation, the inter-network facilitation system 604 may enable users to interact with each other or other entities, or to allow users to interact with these entities through an application programming interfaces (“API”) or other communication channels.

In particular embodiments, the inter-network facilitation system 604 may include a variety of servers, sub-systems, programs, modules, logs, and data stores. In particular embodiments, the inter-network facilitation system 604 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 604 may also include suitable components such as network interfaces, security mechanisms, load balancers, failover servers, management-and-network-operations consoles, other suitable components, or any suitable combination thereof. In particular embodiments, the inter-network facilitation system 604 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 604 and the client device(s) 904. An action logger may be used to receive communications from a web server about a user's actions on or off the inter-network facilitation system 604. In conjunction with the action log, a third-party-content-object log may be maintained of user exposures to third-party-content objects. A notification controller may provide information regarding content objects to the client device(s) 904. Information may be pushed to the client device(s) 904 as notifications, or information may be pulled from the client device(s) 904 responsive to a request received from the client device(s) 904. Authorization servers may be used to enforce one or more privacy settings of the users of the inter-network facilitation system 604. A privacy setting of a user determines how particular information associated with a user can be shared. The authorization server may allow users to opt in to or opt out of having their actions logged by the inter-network facilitation system 604 or shared with other systems, such as, for example, by setting appropriate privacy settings. Third-party-content-object stores may be used to store content objects received from third parties. Location stores may be used for storing location information received from the client device(s) 904 associated with users.

In addition, the third-party system(s) 906 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 604 via the network 902. The third-party system(s) 906 can communicate with the inter-network facilitation system 604 to provide financial information pertaining to balances, transactions, and other information, whereupon the inter-network facilitation system 604 can provide corresponding information for display via the client device(s) 904. In particular embodiments, the third-party system(s) 906 communicates with the inter-network facilitation system 604 to update account balances, transaction histories, credit usage, and other internal information of the inter-network facilitation system 604 and/or the third-party system(s) 906 based on user interaction with the inter-network facilitation system 604 (e.g., via the client device(s) 904). Indeed, the inter-network facilitation system 604 can synchronize information across one or more of the third-party system(s) 906 to reflect accurate account information (e.g., balances, transactions, etc.) across one or more networked systems, including instances where a transaction (e.g., a transfer) from one of the third-party system(s) 906 affects another of the third-party system(s) 906.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
extracting, utilizing a zero-day model of an inter-network facilitation system, zero-day features from a plurality of data sources associated with a user account within the inter-network facilitation system;
determining, from the zero-day features, destination-specific identifiers comprising features specific to one or more matching systems at servers external to the inter-network facilitation system;
generating, utilizing the zero-day model to process the destination-specific identifiers for the user account, a zero-day score indicating a likelihood of the user account establishing a direct-asset-transfer account within the inter-network facilitation system; and
determining, based on the zero-day score, a value-based asset threshold for generating digital content to surface to user accounts.

2. The computer-implemented method of claim 1, wherein determining the destination-specific identifiers comprises:
determining, from the zero-day features, a first subset of the destination-specific identifiers comprising zero-day features that satisfy a threshold impact on the zero-day score;
deriving, utilizing an identifier derivation engine to process the zero-day features comprising a subset of zero-day features that do not satisfy the threshold impact on the zero-day score, a second subset of the destination-specific identifiers that satisfy the threshold impact on the zero-day score; and
combining the first subset of the destination-specific identifiers and the second subset of the destination-specific identifiers.

3. The computer-implemented method of claim 1, wherein extracting the zero-day features from the plurality of data sources comprises extracting, utilizing the zero-day model, the zero-day features within a zero-day period upon receiving an indication of an initiation of the user account.

4. The computer-implemented method of claim 1, further comprising:
generating, utilizing the zero-day model to process a first set of destination-specific identifiers for a first matching system external to the inter-network facilitation system, a first zero-day score specific to the first matching system; and
generating, utilizing the zero-day model to process a second set of destination-specific identifiers for a second matching system external to the inter-network facilitation system, a second zero-day score specific to the second matching system.

5. The computer-implemented method of claim 4, further comprising:
providing the first zero-day score to the first matching system to cause the first matching system to generate digital content to surface to a first set of matching user accounts; and
providing the second zero-day score to the second matching system to cause the second matching system to generate digital content to surface to a second set of matching user accounts.

6. The computer-implemented method of claim 1, further comprising causing the one or more matching systems to generate digital content to surface to at least one external user account associated with the one or more matching systems based on providing, to the one or more matching systems, a zero-day data package comprising the destination-specific identifiers, the zero-day score, and the value-based asset threshold.

7. The computer-implemented method of claim 1, further comprising:
monitoring the zero-day model to detect a data drift comprising a deviation in input data relative to an expected baseline or a deviation in an output feature relative to an expected baseline;
providing, for display on a client device, a data drift notification indicating the data drift; and
modifying the zero-day model to account for the data drift by removing a variable from the input data processed by the zero-day model.

8. A system comprising:
at least one processor; and
at least one non-transitory computer-readable storage medium storing instructions that, when executed by the at least one processor, cause the system to:
extract, utilizing a zero-day model of an inter-network facilitation system, zero-day features from a plurality of data sources associated with a user account within the inter-network facilitation system;
determine, from the zero-day features, destination-specific identifiers comprising features specific to one or more matching systems at servers external to the inter-network facilitation system;
generate, utilizing the zero-day model to process the destination-specific identifiers for the user account, a zero-day score indicating a likelihood of the user account establishing a direct-asset-transfer account within the inter-network facilitation system; and
determine, based on the zero-day score, a value-based asset threshold for generating digital content to surface to user accounts.

9. The system of claim 8, further comprising instructions that, when executed by the at least one processor, cause the system to determine the destination-specific identifiers by:
determining, from the zero-day features, a first subset of the destination-specific identifiers comprising zero-day features that satisfy a threshold impact on the zero-day score;
deriving, utilizing an identifier derivation engine to process the zero-day features comprising a subset of zero-day features that do not satisfy the threshold impact on the zero-day score, a second subset of the destination-specific identifiers that satisfy the threshold impact on the zero-day score; and
combining the first subset of the destination-specific identifiers and the second subset of the destination-specific identifiers.

10. The system of claim 8, further comprising instructions that, when executed by the at least one processor, cause the system to extract the zero-day features from the plurality of data sources comprises extracting, utilizing the zero-day model, the zero-day features within a zero-day period upon receiving an indication of an initiation of the user account.

11. The system of claim 8, further comprising instructions that, when executed by the at least one processor, cause the system to:
generate, utilizing the zero-day model to process a first set of destination-specific identifiers for a first matching system external to the inter-network facilitation system, a first zero-day score specific to the first matching system; and
generate, utilizing the zero-day model to process a second set of destination-specific identifiers for a second matching system external to the inter-network facilitation system, a second zero-day score specific to the second matching system.

12. The system of claim 11, further comprising instructions that, when executed by the at least one processor, cause the system to:
provide the first zero-day score to the first matching system to cause the first matching system to generate digital content to surface to a first set of matching user accounts; and
provide the second zero-day score to the second matching system to cause the second matching system to generate digital content to surface to a second set of matching user accounts.

13. The system of claim 8, further comprising instructions that, when executed by the at least one processor, cause the system to cause the one or more matching systems to generate digital content to surface to at least one external user account associated with the one or more matching systems based on providing, to the one or more matching systems, a zero-day data package comprising the destination-specific identifiers, the zero-day score, and the value-based asset threshold.

14. The system of claim 8, further comprising instructions that, when executed by the at least one processor, cause the system to:
monitor the zero-day model to detect a data drift comprising a deviation in input data relative to an expected baseline or a deviation in an output feature relative to an expected baseline;
provide, for display on a client device, a data drift notification indicating the data drift; and
modify the zero-day model to account for the data drift by removing a variable from the input data processed by the zero-day model.

15. A non-transitory computer-readable medium storing instructions that, when executed by at least one processor, cause a computing device to:
extract, utilizing a zero-day model of an inter-network facilitation system, zero-day features from a plurality of data sources associated with a user account within the inter-network facilitation system;
determine, from the zero-day features, destination-specific identifiers comprising features specific to one or more matching systems at servers external to the inter-network facilitation system;
generate, utilizing the zero-day model to process the destination-specific identifiers for the user account, a zero-day score indicating a likelihood of the user account establishing a direct-asset-transfer account within the inter-network facilitation system; and
determine, based on the zero-day score, a value-based asset threshold for generating digital content to surface to user accounts.

16. The non-transitory computer-readable medium of claim 15, further comprising instructions that, when executed by the at least one processor, cause the computing device to determine the destination-specific identifiers by:
determining, from the zero-day features, a first subset of the destination-specific identifiers comprising zero-day features that satisfy a threshold impact on the zero-day score;
deriving, utilizing an identifier derivation engine to process the zero-day features comprising a subset of zero-day features that do not satisfy the threshold impact on the zero-day score, a second subset of the destination-specific identifiers that satisfy the threshold impact on the zero-day score; and
combining the first subset of the destination-specific identifiers and the second subset of the destination-specific identifiers.

17. The non-transitory computer-readable medium of claim 15, further comprising instructions that, when executed by the at least one processor, cause the computing device to extract the zero-day features from the plurality of data sources comprises extracting, utilizing the zero-day model, the zero-day features within a zero-day period upon receiving an indication of an initiation of the user account.

18. The non-transitory computer-readable medium of claim 15, further comprising instructions that, when executed by the at least one processor, cause the computing device to:
generate, utilizing the zero-day model to process a first set of destination-specific identifiers for a first matching system external to the inter-network facilitation system, a first zero-day score specific to the first matching system; and
generate, utilizing the zero-day model to process a second set of destination-specific identifiers for a second matching system external to the inter-network facilitation system, a second zero-day score specific to the second matching system.

19. The non-transitory computer-readable medium of claim 15, further comprising instructions that, when executed by the at least one processor, cause the computing device to cause the one or more matching systems to generate digital content to surface to at least one external user account associated with the one or more matching systems based on providing, to the one or more matching systems, a zero-day data package comprising the destination-specific identifiers, the zero-day score, and the value-based asset threshold.

20. The non-transitory computer-readable medium of claim 15, further comprising instructions that, when executed by the at least one processor, cause the computing device to:
monitor the zero-day model to detect a data drift comprising a deviation in input data relative to an expected baseline or a deviation in an output feature relative to an expected baseline;
provide, for display on a client device, a data drift notification indicating the data drift; and
modify the zero-day model to account for the data drift by removing a variable from the input data processed by the zero-day model.
